(19) United States
(12) Patent Application Publication
(10) Pub. No.: US 2015/0283660 A1
(43) Pub. Date: Oct. 8, 2015

(54) TABLE FOR WORKING ON CIRCULARLY ARCUATE COMPONENT

(71) Applicant: General Electric Company, Schenectady, NY (US)

(72) Inventors: Paul James Cassidy, Altamont, NY (US); John Peter Hoffman, St. Francis, MN (US); David Allan Hultman, Lindstrom, MN (US); John Matthew Sassatelli, Valley Falls, NY (US)

(73) Assignee: General Electric Company, Schenectady, NY (US)

(21) Appl. No.: 14/245,361

(22) Filed: Apr. 4, 2014

(51) Int. Cl. B23Q 1/25; B23Q 9/00; B23P 6/00

(52) U.S. Cl. CPC B23Q 1/25; B23P 6/002; B23Q 9/0064

(57) ABSTRACT

A table for use in working on a circularly arcuate component is disclosed. The table includes a base frame and a first work surface mounted to the base frame, the first work surface including at least one linearly slidable work section separable from a remaining portion of the first work surface. A fastener for holding a circularly arcuate component relative to the at least one linearly slidable work section is provided. A mount for mounting a machining tool for machining the circularly arcuate component or a circular component may also be provided.

### BACKGROUND OF THE INVENTION

The disclosure relates generally to repair and maintenance work of industrial devices, and more particularly, to a table for working on a circularly arcuate component such as a turbine diaphragm half.

Industrial devices require periodic repair and maintenance. For example, turbines are subject to periodic shut downs in the field during which repairs and maintenance are conducted. Oftentimes, parts cannot be repaired at the site of the industrial device and must be shipped to an off-site location, and then returned once repaired for re-installation. The need to ship parts for repair is particularly acute for large specially shaped parts, e.g., arcuate shaped components, because the special shape makes on-site repair very difficult. The time required to ship, repair and return the parts constitutes down time for the industrial device, which can be costly for the owner. In many cases, the off-site repair is completed by a third party vendor to the entity that is performing the overall repair work. Consequently, the quality of the repair is reliant on the quality of the off-site vendor.

One part that typically requires off-site repair is a turbine diaphragm. A turbine diaphragm separates a turbine stage from an adjacent turbine stage, for example, in a steam or gas turbine. The diaphragm usually is made of wrought or cast steel. A hub of the diaphragm includes close fitting packings to reduce leakage of steam, and a rim thereof is coupled to the turbine cylinder, e.g., using dovetail couplings. Each turbine diaphragm usually includes two large, semi-circular parts that mate to form the circular diaphragm, making highly accurate on-site repair nearly impossible. Typically, turbine diaphragms must be sent off site for repair, creating costly and long outages.

### BRIEF DESCRIPTION OF THE INVENTION

A first aspect of the disclosure provides a table for use in working on a circularly arcuate component, the table comprising: a base frame; a first work surface mounted to the base frame, the first work surface including at least one linearly slidable work section separable from a remaining portion of the first work surface; and a fastener for holding a circularly arcuate component relative to the at least one linearly slidable work section.

A second aspect of the disclosure provides a multiple use table for use in working on a circularly arcuate component, the table comprising: a base frame; a first work surface mounted to the base frame, the first work surface including a pair of opposing linearly slidable work sections, each work section including a fastener for holding a circularly arcuate component relative thereto, wherein the pair of linearly movable work sections are movable between a separated position in which each circularly arcuate component is separated from the other circularly arcuate component and a proximate position in which the circularly arcuate components form a circular component; and a mount for mounting a milling tool for machining one of a circularly arcuate component in the separated position and the circular component in the proximate position.

A third aspect of the disclosure provides a multiple use table for use in working on a circularly arcuate component, the table comprising: a base frame; a first work surface mounted to the base frame, the first work surface including a pair of opposing linearly slidable work sections movable between a separated position and a proximate position in which each work section is in at least close proximity to the other work section; a fastener for holding a circularly arcuate component relative to the first work surface; a boring bar extending through the first work surface; a first bearing for the boring bar positioned below the first work surface and a second bearing for the boring bar positioned above the first work surface; and a rotation power source coupled to the boring bar.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a front perspective view of a table according to embodiments of the invention.

FIG. 2 shows a front perspective view of the table of FIG. 1 with a pair of circularly arcuate components mounted thereto in a retracted position.

FIG. 3 shows a front perspective view of the table of FIG. 2 with the pair of circularly arcuate components mounted thereto in a proximal position.

FIG. 4 shows a front perspective view of the table of FIG. 1 with a work section removed.

FIG. 5 shows a side perspective detail view of a linear bearing.

FIG. 6 shows a side, partially cross-sectioned, perspective detail view of a lock for work sections of the table.

FIG. 7 shows a side perspective detail view of a milling tool.

FIGS. 8 and 9 show side perspective views of an alternative embodiment of a milling tool mount.

FIG. 10 shows a side view of an alternative embodiment of a milling tool mount.

FIG. 11 shows a plan perspective view of an alternative embodiment of a milling tool and milling tool mount.

FIG. 12 shows a plan perspective view of an alternative embodiment of a cutting tool and cutting tool mount.

FIGS. 13-14 show conceptual side views of locations of bearings for a boring bar.

FIG. 15 shows a side perspective view of the table including a rotational cutting tool.

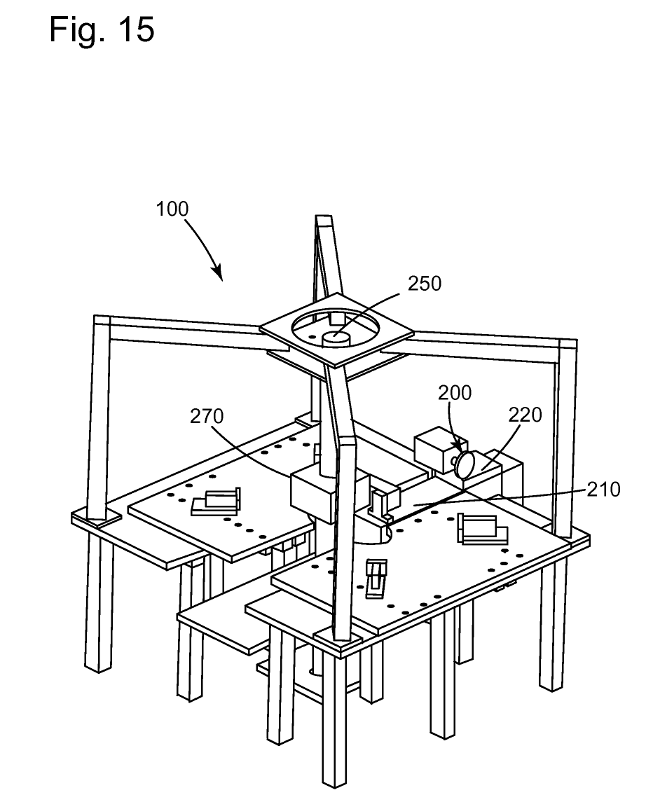

FIG. 16 shows a side detail view of a rotational cutting tool cutting a circumferential attribute of a circular component.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As indicated above, the disclosure provides a table for use in working on a circularly arcuate component or a circular component, i.e., two semi-circularly arcuate components combined. Each circularly arcuate component may be part of any now known or later developed industrial device. In one application, the background of which was described herein, a circularly arcuate component may include a turbine diaphragm half. A turbine diaphragm is a structure that separates a turbine stage from an adjacent turbine stage, for example, in a gas or steam turbine. In a gas turbine, these structures may be referred to as nozzles. The diaphragm usually is made of wrought or cast steel. In addition to a turbine diaphragm half, as used herein, “circularly arcuate component” may include any part that is assembled to a 360 degree annular shape, but disassembled into smaller pieces for servicing. For example, circularly arcuate component may include other semi-circular structures such as an exhaust plenum. As illustrated herein, each circularly arcuate component includes a semi-circular component, e.g., a turbine diaphragm half, that can mate to form a circular component, e.g., a complete turbine diaphragm. As will be apparent, however, the table as disclosed herein, may find application to any range of circularly arcuate component, not just semi-circular or circular structures.

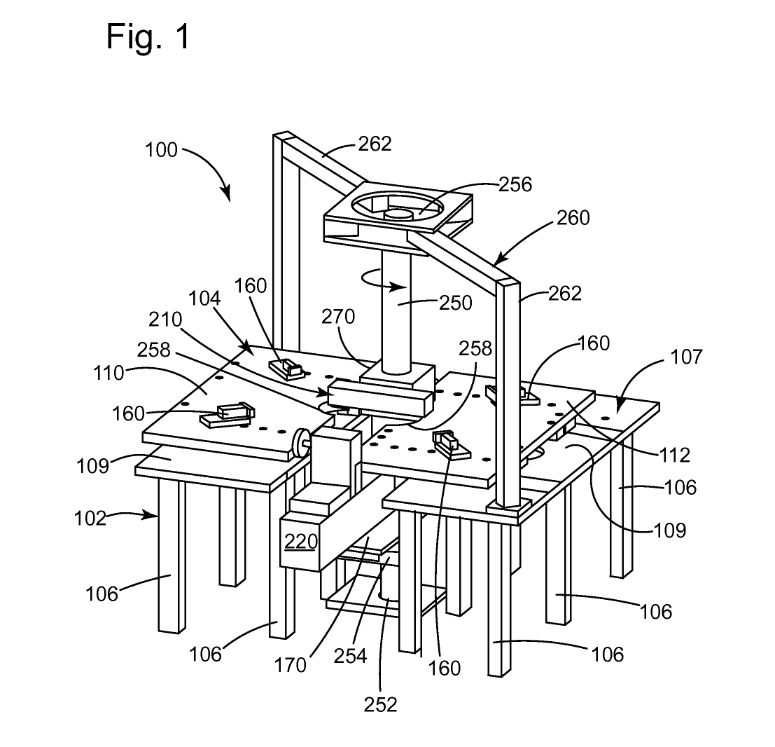

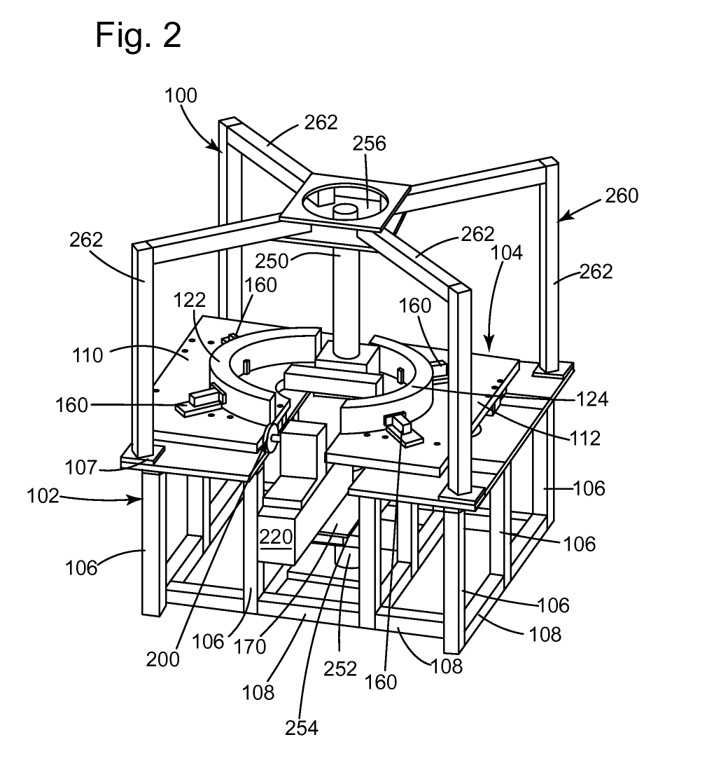

Referring to the drawings, a table 100 according to various embodiments of the invention is illustrated. As shown in FIGS. 1-2, table 100 includes a base frame 102 and a first work surface 104 mounted to base frame 102. Base frame 102 may include any now known or later developed support structure for a table top such as a number of vertical legs 106. Vertical legs 106 may be coupled together by various leg connectors 108 (FIG. 2 only); however, as shown in FIG. 1, this is not necessary in all cases. Table 100 may be made of any suitably strong metal, such as steel. Base frame 102 may include a top structure 107 that ties legs 106 together. As illustrated, top structure 107 may include a pair of opposing plates 109, but it may include any structure capable of positioning legs 106 and allowing the other structure of table 100 to be coupled appropriately to base frame 102, e.g., simple bar connectors similar to leg connectors 108.

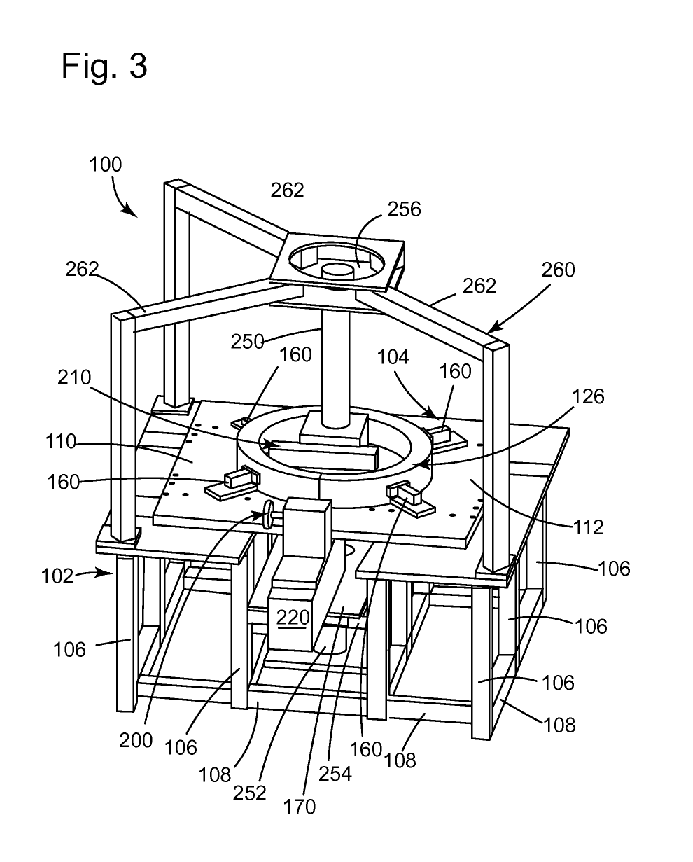

First work surface 104 may include at least one linearly slidable work section 110 separable from a remaining portion 112 of the first work surface. Where only one work section is linearly slidable, as shown in FIG. 1, a single linearly slidable work section 110 can move away from a stationary work section 112. In this case, work section 112 would be fixed in place, e.g., using welds, bolts, a temporarily locked bearing, etc. In an alternative embodiment, first work surface 104 may include a pair of opposing linearly slidable work sections 110, 112 movable between a separated position, shown in FIGS. 1 and 2, and a proximate position, shown in FIG. 3, in which each work section 110, 112 is in at least close proximity to the other work section. As will be described in greater detail herein and shown in FIGS. 2 and 3, each work section 110, 112 may have a circularly arcuate member 122, 124, respectively, positioned thereon. In this fashion, pair of linearly movable work sections 110, 112 are movable between a separated position, shown in FIGS. 1 and 2, in which each circularly arcuate component 122, 124 is separated from the other circularly arcuate component 122, 124 and a proximate position, shown in FIG. 3, in which the circularly arcuate components 122, 124 form a circular component 126. Each work section 110, 112 is capable of being in a proximate position and any number of retracted positions. In the turbine diaphragm example, a turbine diaphragm 126 (FIG. 3) may be separable into turbine diaphragm halves 122, 124. As will be described herein, turbine diaphragm 126 may be worked on as a single unit, or each half 122, 124 may be worked on separately using table 100.

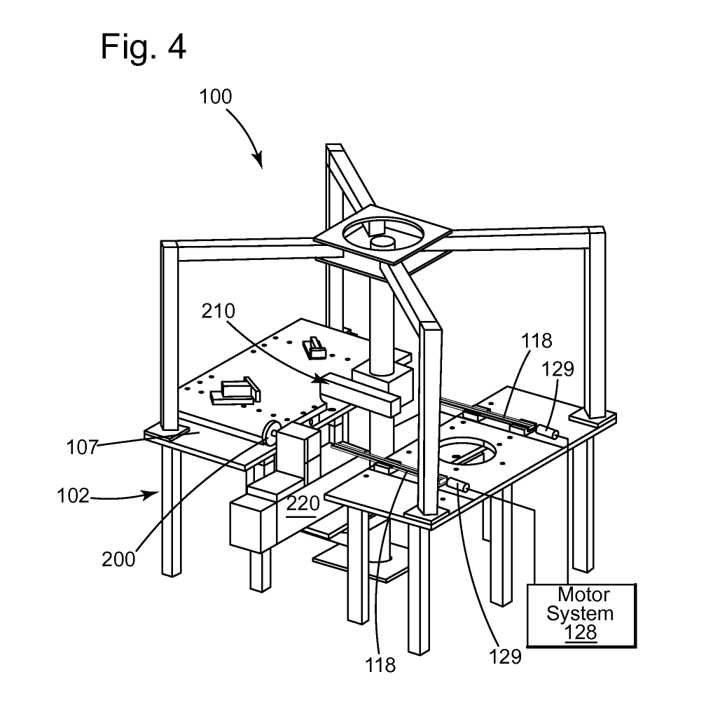

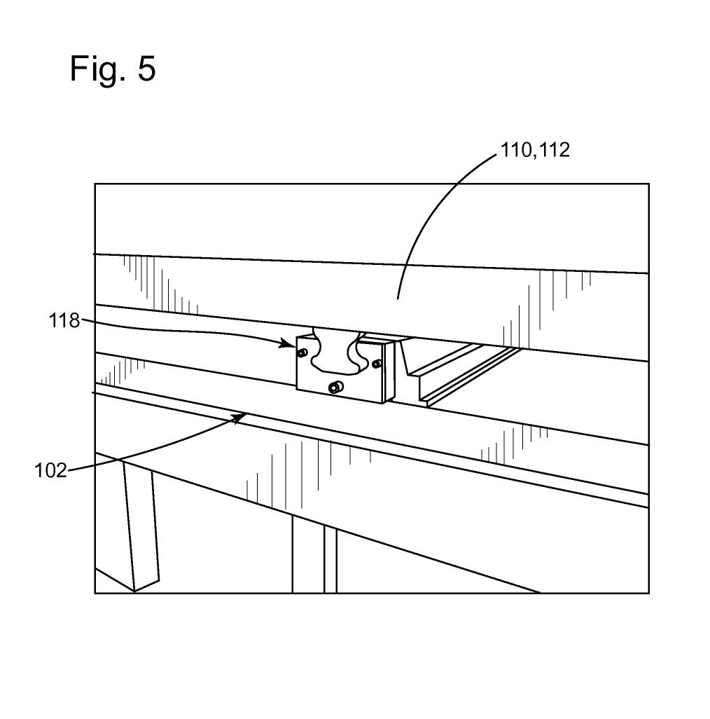

Each work section 110, 112 that is linearly slidable may be made linearly slidable relative to base frame 102 using any of a variety of now known or later developed linear bearings, which may or may not be coupled with a linear drive mechanism such as a rack-and-pinion or lead screw arrangement. Turning to FIG. 4, table 100 shown in FIG. 2 is illustrated with work section 112 removed to reveal one embodiment of linear bearings 118 that may be employed. In this case, as shown in a detail view in FIG. 5, each linear bearing 118 may include a mating linear bearing, i.e., with one male/female part fixed to base frame 102 and the other male/female part fixed to work section 110 or 112 to allow to linear movement thereof. While the example shown in FIG. 5 includes a mating dovetail shaped bearing, it is emphasized that any variety of linear bearing may be employed. While FIG. 4 shows a pair of linear bearings 118, any number necessary for smooth action may be employed, e.g., one, two, three, four, etc. In an alternative embodiment, although not necessary in all settings, a position of linearly slidable work section(s) 110, 112 may be controlled by a motor system 128. Motor system 128 may include, e.g., a pair of linear drive motors 129 for work section(s) 110, 112, and appropriate control mechanisms. Drive motors 129 may be coupled to work section(s) 110, 112 or operate in conjunction with bearings 118, in any known fashion, such as with use of a lead screw (turnable by motor 129 and coupled to work section(s) 110, 112) or a rack-and-pinion arrangement (pinion gear attached to motor, rack gear on work section). As understood, drive motors 129 can be positioned in alternative locations than those illustrated to accommodate the different drive arrangements.

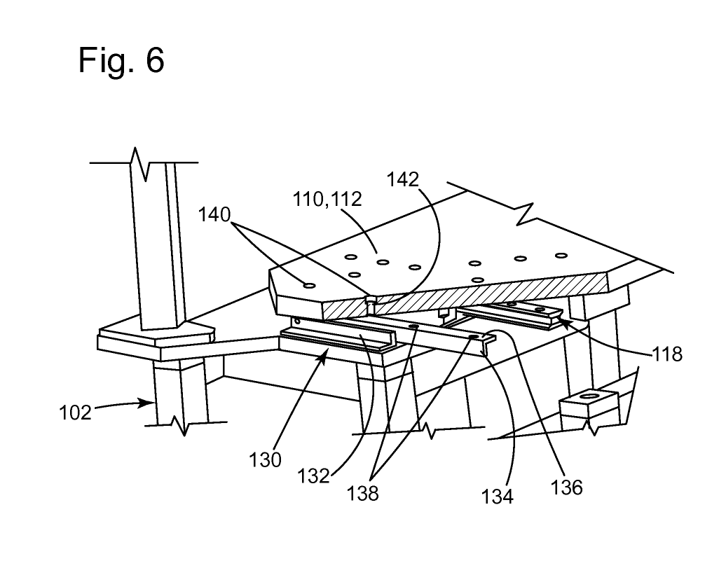

Referring to FIG. 6, table 100 may include a lock 130 for fixing pair of opposing linearly slidable work sections 110, 112 in a position, such as the proximate position, is illustrated. Lock 130 may take a variety of forms. In the example shown, lock 130 may includes a first L-shaped bar 132 with one side thereof coupled to base frame 102, and a second L-shaped bar 134 with one side 136 thereof facing section 110 or 112. The other sides of each L-shaped bar 130, 132 extend to be coupled to one another, e.g., by welding, rivets, bolts, etc. Side 136 of bar 134 that faces work section 110, 112 may include a number of openings 138 along a length thereof. Each work section 110, 112 may include one or more openings 140 (shown in cut away portion of section(s)) that may be positioned to align with an opening 138 such that a removable pin 142 may be positioned to prevent linear movement of work section 110, 112. Each work section 110, 112 may include a similar lock 130. Each lock 130 may include a plurality of mating openings 138, 140 such that work section(s) 110, 112 may be locked in a number of locations. While one form of lock 130 has been illustrated, it is understood that a variety of other locks may be employed within the scope of the invention such as but not limited to: clamps, motor positioning, etc.

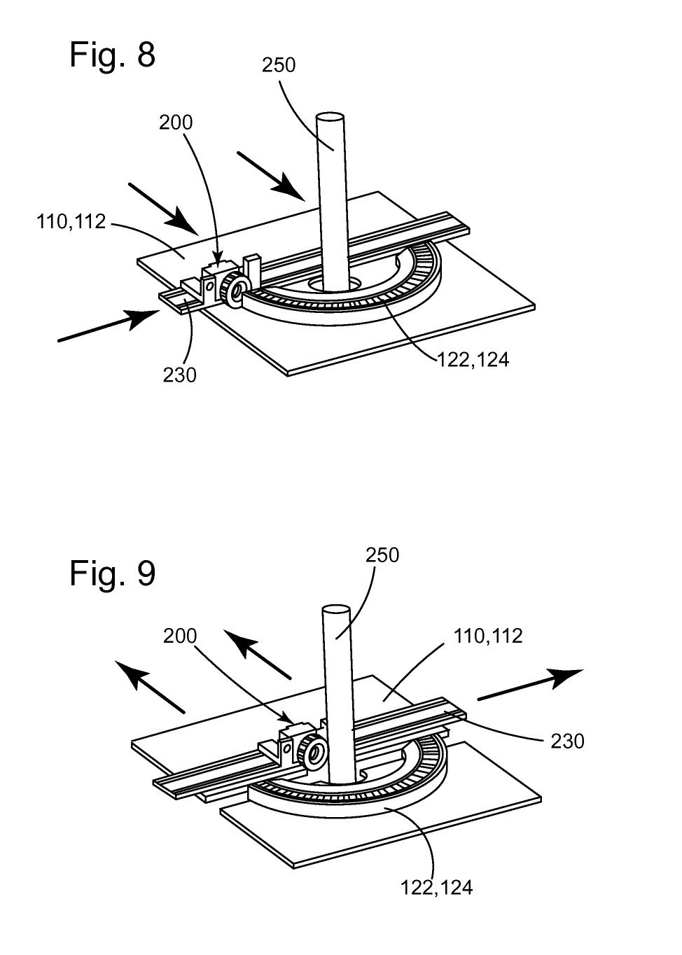

Returning to FIGS. 2-3, each linearly slidable work section 110, 112 includes a fastener 160 for holding a circularly arcuate component 122 or 124 (FIG. 2) relative to the respective linearly slidable work section 110, 112, e.g., in an appropriately aligned manner. In the embodiments shown, two fasteners 160 are coupled to each work section 110, 112. However, any number of fasteners 160 required to hold a particular component may be employed, e.g., one, two, three, four, etc. In one embodiment, as illustrated, each fastener 160 includes a clamp adjustably mounted to the work section(s) 110, 112. Each clamp may act to grip component 122, 124 directly, or may act with an opposing structure, e.g., a movable post (not shown) positioned on an interior side of component 122, 124 and affixed to work section(s) 110, 112. Fastener 160 may also include provisions for positioning component 122, 124 vertically and/or circumferentially, and may be automated, e.g., using hydraulics, pneumatics, electric motor control, etc., for precision purposes. Fastener 160 may also affix to component 122, 124, e.g., using bolts, adhesives, etc., where necessary. In the turbine diaphragm example, each work section 110, 112 can position a turbine diaphragm half, via fasteners 160, such that they can be repaired separately (FIG. 2). In addition, as shown in FIG. 3, each work section 110, 112 may position a respective circularly arcuate component 122, 124 such that the components form a circular component 126 in response to the pair of opposing slidable work sections 110, 112 being in the proximate position. In this fashion, as will be described, a turbine diaphragm can be repaired as a whole unit. In any event, fastener(s) 160 thus allow for accurate positioning of diaphragm halves, e.g., concentric to boring bar 250 (described herein) for circular machining, or perpendicular to work sections 110, 112 for machining joint faces 202 (FIGS. 8, 11, 12) of the diaphragm halves.

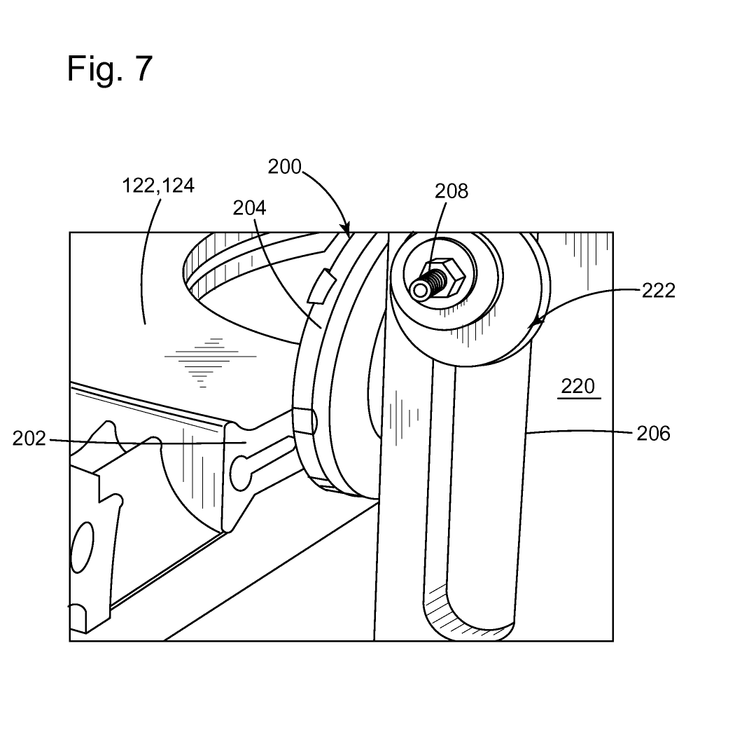

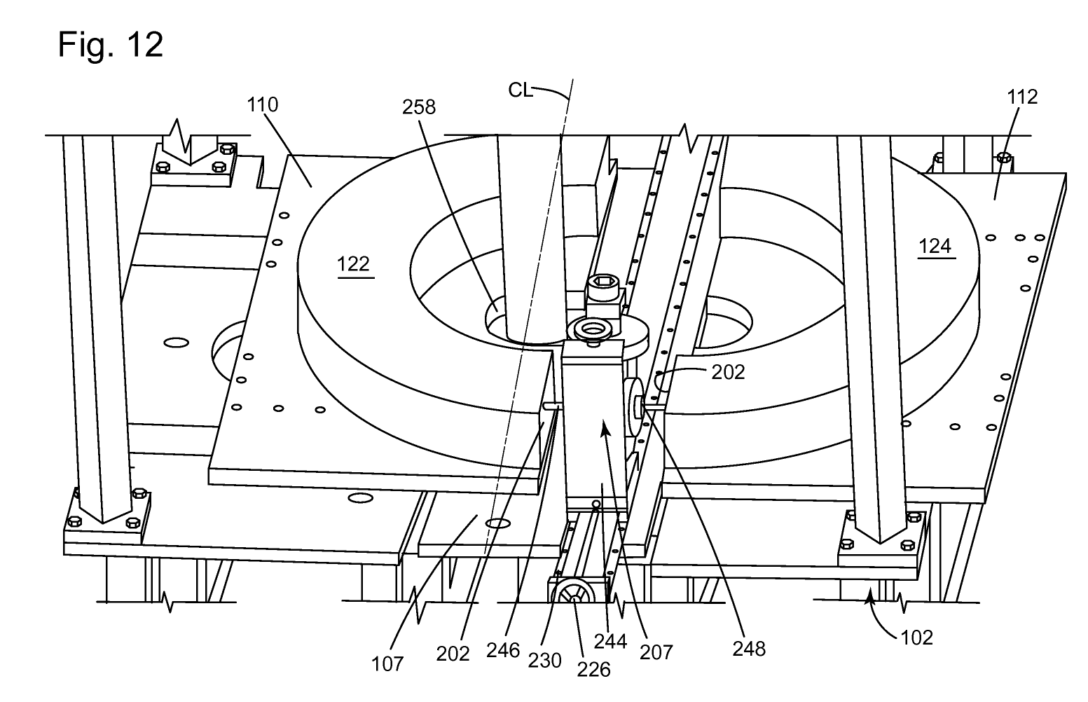

Table 100 also includes a number of features to allow for working on circularly arcuate components 122, 124. In one embodiment, as shown in FIGS. 1-4 and 7, table 100 may include a number of machining tools. One such tool, as shown in detail in FIG. 7, includes a linear milling tool 200 configured for mounting to the table and linear milling of a joint face 202 of circularly arcuate component(s) 122, 124. As used herein, a “joint face” of circularly arcuate component 122, 124 includes a surface(s) of the component that abuts and/or mates with an opposing surface of the other component to form a joint. Milling tool 200 includes a rotating milling head 204 mounted to a rotation power source such as a motor, perhaps using an appropriate gear box (e.g., right angle gear box). In addition or as an alternative, as shown in FIG. 12, a machining tool may include a cutting tool 207 for cutting a groove or key into a joint face 202 of circularly arcuate component(s) 122, 124. In addition or as an alternative, as shown in FIGS. 1-4, 13 and 14, table 100 may also include a rotational cutting tool 210 configured for mounting to the table and rotationally cutting a circumferential attribute of the circularly arcuate component 122, 124 (or circular component 126 (FIG. 3). A “circumferential attribute” may include any feature of component 122, 124 or 126 (e.g., an inner or outer diameter, or a top or bottom or intermediate surface) capable of work being done thereon by a tool following a circular path. Rotational cutting tool 210, as will be described, can be powered by a rotation power source such as a motor, perhaps using an appropriate gear box. Rotating cutting tool 210, as will be described, may be mounted by a mount 270 to a boring bar 250. In any event, a variety of mounts 220, 230, 270 may be provided for mounting a machining tool, e.g., milling tool 200, cutting tool 207 and/or rotational cutting tool 210, for machining one of a circularly arcuate component 122, 124 in the separated position (see FIGS. 2 and 7) and circular component 126 in the proximate position (see FIGS. 3 and 14). Mounts 220, 230, 270 can take a variety of forms.

As shown in FIGS. 1-3, table 100 may also include a second work surface 170 positioned below first work surface 104 such that it is at least partially overlapped by linearly slidable work section(s) 110, 112, e.g., in the proximate position of FIG. 3. That is, second work surface 170 is accessible when one or more work sections 110, 112 are at least partially retracted from the proximate position of FIG. 3. Second work surface 170 may be positioned within base frame 102 such that it forms a unitary structure with first work surface 104. Second work surface 170 may provide support for a variety of tools. For example, as shown in FIGS. 2 and 7, milling tool 200 may be mounted to second work surface 170 (FIG. 2 only) positioned below first work surface 104, allowing milling of joint face 202 (FIG. 8 only) of the circularly arcuate component 122, 124. In this case, mount 220 may include any form of support structure, e.g., a metal box, capable of being coupled to second work surface 170 and positioning milling tool 200 such that a milling cutter or head 204 thereof can work on joint face 202 (FIG. 7 only). As shown in FIG. 7, mount 220 may include a height adjuster 222 including, for example, a user position selectable, bolt-in-slot mechanism 206, 208 to lock a vertical position of the milling tool 200. In this example, the part including slot 206 is mounted to second work surface 170 and another part including bolt 208 is coupled to cutter 204 such that loosening/tightening of a nut on bolt 206 allows vertical adjustment. A variety of other position adjustment mechanisms may be employed in place of the bolt-in-slot mechanism illustrated, including but not limited to a motor controlled system, a peg-in-hole system (see lock 130 in FIG. 6), etc.

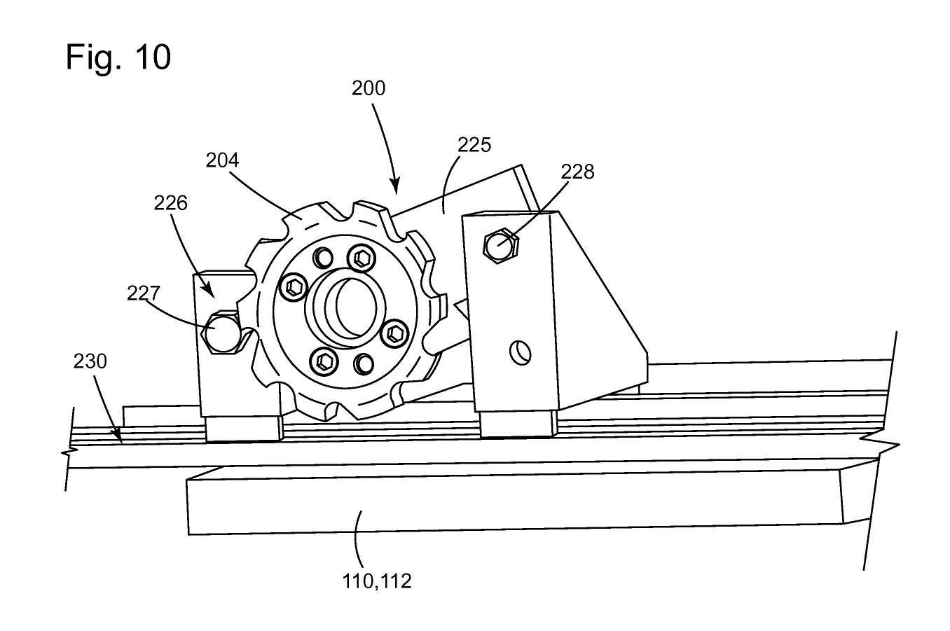

In an alternative embodiment, shown in FIGS. 8 and 9, milling tool 200 may be mounted to one of linearly slidable work sections 110 or 112 by a track 230, allowing milling of a joint face 202 (FIG. 7 only) of the circularly arcuate component. In operation, work section 110 with milling tool 200 mounted thereto is positioned in the proximate position, shown in FIG. 8, in which milling tool 200 mills/cuts a joint face of one end of circularly arcuate component 122, 124. As shown in FIG. 9, work section 110 may then be moved to a retracted position, allowing milling tool 200 to laterally pass by boring bar 250 (described herein). Work section 110, 112 can then be returned to the proximate position, shown in FIG. 8, but with milling tool 200 in position to cut the joint face at the other end of circularly arcuate component 122, 124. Work section 110 location would be used to control depth of cutting, i.e., with motor control with the addition of, for example, a lead screw. Movement of milling tool 200 along track 230 can be controlled by any motorized mechanism such as a motor controlled lead screw or rack-and-pinion arrangement, as described herein relative to work sections 110, 112. As with the FIG. 7 embodiment, vertical adjustment of milling tool 200 is advantageous. Here, milling tool may be vertically adjusted as illustrated in FIG. 7. Alternatively, as shown in FIG. 10, milling tool 200 may be vertically adjusted by a pivot arrangement 226. In this case, milling tool 200 may be mounted to a pivoting bar 225 that is fixedly pivotally coupled to track 230 at one end 227 and pivoted to a number of vertical positions at an opposing end 228, allowing selection of a vertical position of milling tool 200. In this case, a larger faced milling tool 200 (large rotating head 204) may eliminate the need for height translation (as in FIG. 7) and the simpler pivot arrangement 226 could be used for machining a joint face 202 (FIG. 7)(of, for example, a diaphragm half) thicker than the diameter of milling tool head 204. While the vertical adjustments of FIGS. 7 and 10 are illustrated with a particular mount 220, 230, it is understood that the vertical adjustment systems illustrated can be used interchangeably.

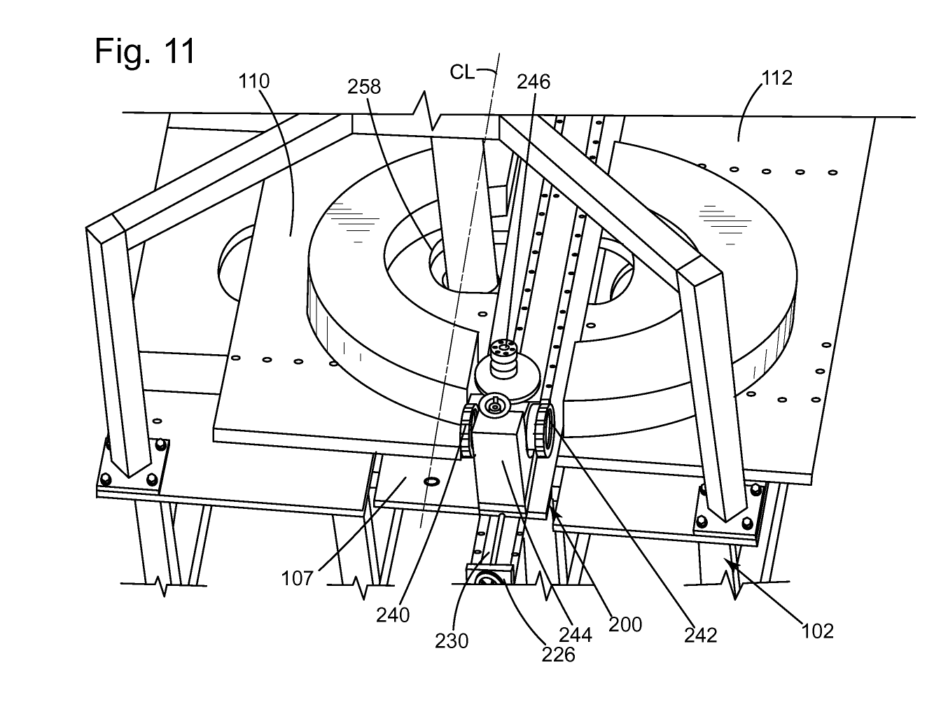

Referring to FIG. 11, another alternative embodiment relating to milling tool 200 is illustrated. In this case, milling tool 200 is mounted to base frame 102 by track 230 and includes two oppositely facing heads 240, 242, allowing milling of joint faces 202 of a pair of opposing circularly arcuate components 122, 124 simultaneously. A right angle gear box 244 driven by a motor 246, for example, a hydraulic motor, may be employed to drive both heads 240, 242. In this example, track 230 is mounted to base frame 102, e.g., upper leg connectors or top structure 107, rather than one of work sections 110, 112. By allowing one of work sections 110 or 112 (110 as shown) to travel past a centerline CL to clear boring bar 250 (described herein), both joint faces 202 (FIG. 7) of opposing circularly arcuate components 122, 124 can be machined in parallel in one setup. In this case, a cut out 258 on one or both of work sections 110, 112 may need to be made deeper (than those shown in FIGS. 1-3) so that work section 110 can extend past the centerline CL, i.e., past the proximate position of FIG. 3. Referring to FIG. 12, smaller double sided cutters 246, 248 could be used for cutting keys or grooves into components 122, 134 providing a mirrored cut for perfect alignment. Cutters 246, 248 could also be used separately in arrangements similar to those illustrated in FIGS. 1-4, 7-9. In either of the above-described track embodiments, second work surface 170 (FIGS. 1-3) and/or two plates 109 (FIG. 1)(if latter is used), would not be necessary since base frame 102 is all that is needed to provide the particular axis of operation. Work sections 110, 112 would be set in a position (i.e., locked) by a controlled motor system, e.g., lead screws or rack-and-pinion arrangement as described herein, eliminating the need to have positive position locks 130 (FIG. 6).

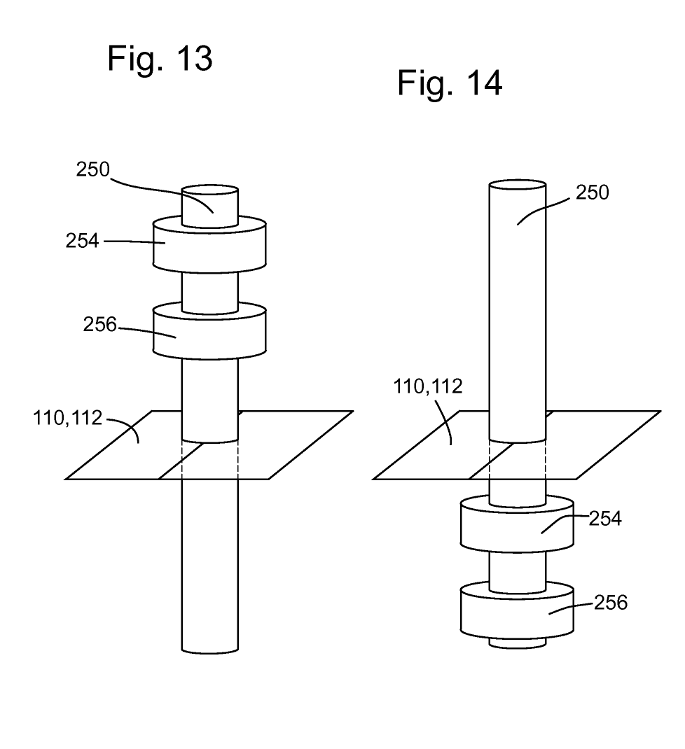

Returning to FIGS. 1-3, table 100 may also include a boring bar 250 extending through first work surface 104, and a rotation power source 252 coupled to the boring bar. Rotation power source 252 acts to turn boring bar 250 about a vertical axis, as illustrated in FIG. 1. A first bearing 254 for boring bar 250 may be positioned below first work surface 104 and a second bearing 256 for boring bar 250 may be positioned above first work surface 104. Bearings 254, 256 act to rotationally mount boring bar 250 to table 100, and may include any now known or later developed rotational bearing. Bearing 254, 256 above and below work sections 110, 112 (i.e., above and below circularly arcuate components 122, 124), inter alia, improves machining accuracy, reduces chatter during machining, and provides a positive reference point for alignment of annular/circular shaped objects. As illustrated, first bearing 254 may be mounted to base frame 102, e.g., by bolts, welds, etc. Table 100 may also include a support 260 for positioning second bearing 256 above first work surface 250. As observed by comparing FIGS. 1, 2 and 3, support 260 may take a variety of forms. For example, support 260 may include: a pair of opposing angle arms 262 mounted to base frame 102 (FIG. 1); two pairs of opposing angle arms 262 mounted to base frame 102 (FIG. 2); or three angle arms 262 mounted to base frame 102. Although support 260 is shown with angle arms 262, it is understood that a large variety of other forms of support for bearing 256 may be employed, e.g., mounting second bearing 256 to a fixed structure about table 100 where table 100 is to be permanently fixed in position. In addition, arms 262 do not necessarily have to take the exact form as illustrated as other shapes may be possible, e.g., arcuate. Furthermore, first bearing 254 and/or second bearing 256 may not be necessary in all instances, e.g., where rotation power source 252 provides sufficient bearing support (perhaps with first bearing 254) to provide precise rotational stability for boring bar 250. In an alternative embodiment, bearings 254, 256 need not be on opposite sides of work sections 110, 112. For example, as shown conceptually in FIGS. 13-14, bearings 254, 256 may both be above work sections 110, 112 (FIG. 13) or both be below work sections 110, 112 (FIG. 14), where sufficient support to allow for accurate machining is provided by the bearings.

As illustrated, boring bar 250 is positioned in a center of table 100 such that circularly arcuate components 122, 124 (FIG. 2) and/or circular component 126 (FIG. 3), when positioned on work sections 110, 112 by fasteners 160 is/are in the proximate position (112 in FIG. 2 only, both in FIG. 3) are concentric to boring bar 250. Various alignment mechanisms, in conjunction with fasteners 160, may be employed to ensure concentricity, e.g., various indicia, laser alignment systems, etc. As shown in FIG. 1, each work section 110, 112 may include a cut out 258 to allow boring bar 250 to pass through first work surface 104 in the retracted position (FIG. 3). Similar openings (not numbered) may be provided in second work surface 170 and/or plate(s) 109, where provided.

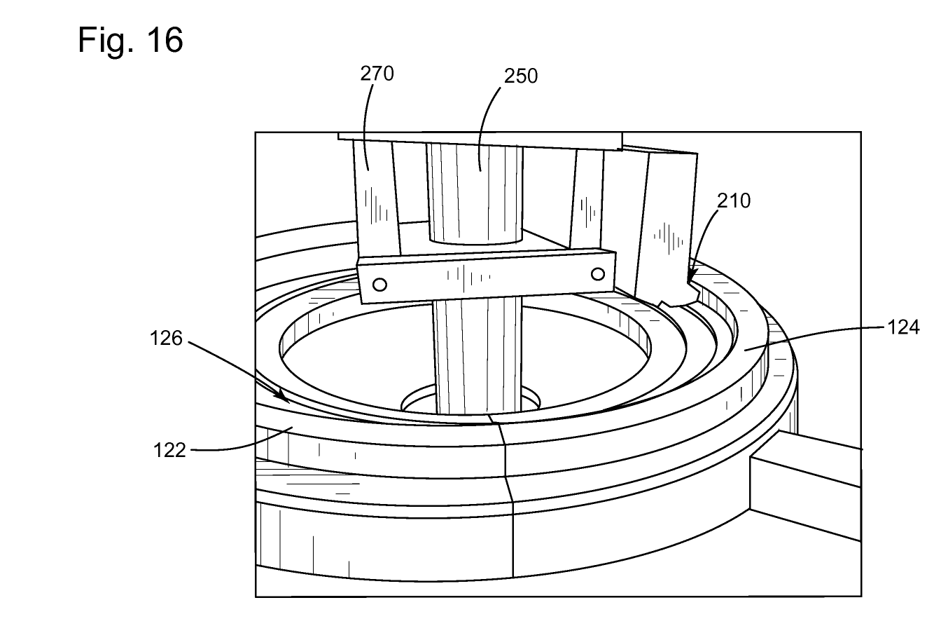

As also shown in FIGS. 2-3, 13 and 14, a machining tool in the form of a rotational cutting tool 210 may be mounted to table 100 and, in particular, to boring bar 250, which extends through first work surface 104. In operation, boring bar 250 turns rotational cutting tool 210 to make circumferential cuts to circularly arcuate component 122, 124 (including circular component 126 (FIG. 3)). As shown best in FIG. 16, rotational cutting tool 210 may be mounted to boring bar 250 by a clamping mount 270 including a number of plates that attach to boring bar 250. In this fashion, rotational cutting tool 210 may be turned in a precise manner to make cuts to a circumferential attribute of circularly arcuate components 122, 124 individually (see FIG. 2 or 3), or collectively as circular component 125 (FIGS. 3 and 14), by rotation power source 252. Rotation power source 252 has sufficient power and precision to ensure smooth cutting.

Although particular forms of motor and other power sources have been described herein, it is emphasized that they can be powered using any now known or later developed power source, including but not limited to hydraulics, pneumatics, electric, etc. The locations of components can be controlled at a centralized set of motor controls, such as shown in FIG. 4 for motors 129, and the precise locations of moving table parts controlled thereby. In addition, the positions of the various parts of table 100 can be precisely identified using any known linear scales, sensors and digital readouts. In particular, operation of each machining tools 200, 207, 210 may be electrically controlled by a control system to precisely position component 122, 124 relative to head(s)/cutter(s) thereof. Where indicia are used, they can be laid out on table 100 in a number of locations to ensure proper positioning, e.g., on work sections 110, 112, along track 230, in milling tool vertical adjusters 222 (FIG. 7), 225, 226 (FIG. 11), on top structure 107, etc.

Table 100 is sized to be portable such that it may be readily moved from one location to another. In particular, table 100 is preferably sized to fit into standard shipping containers, and can be readily moved using, for example, a forklift or crane. The standard shipping container may be one of a number sizes designated by the International Organization for Standardization (ISO), and may be known by other names, such as “intermodal container” or “intermodal freight shipping container.” There are five common standard ISO lengths: 20-ft (6.1 m), 40-ft (12.2 m), 45-ft (13.7 m), 48-ft (14.6 m), and 53-ft (16.2 m). Typical width and height dimensions for the containers are 8 ft wide and 8 feet 6 inches high. However, it is to be appreciated that the current disclosure would encompass other ISO standard length containers. Of course, it is possible to use other dimensions. It is contemplated that other container sizes could be utilized in accordance with an aspect of the present invention. The shipping container has the shape of a rectangular cuboid or rectangular box which has six sides with each side being a rectangle or square, with each face being effectively perpendicular to the adjacent faces, and with opposed faces being effectively the same size and parallel to each other. The portability of table 100 using a standard shipping container allows use of the table to repair circularly arcuate components, such as turbine diaphragm halves, on site at a number of locations. Consequently, table 100 reduces industrial device outage time. For example, for a steam turbine, table 100 may reduce outage time by days, saving an owner time and expense. Shipping costs for sending/receiving components to a third-party repair shop are also eliminated, and the component repair capacity on site is increased due to the elimination of sending components off site. In addition, since table 100 may combine a vertical boring bar 250 (rotational cutting tool 210) and horizontal milling tool 200, a large number of operations can be performed on one piece of equipment with a single setup with a high degree of accuracy. For example, for steam turbine diaphragms, rotating cutting tool 210 can be used to machine spill strip dovetails, steam joint faces, appendages, steam paths, etc. Separating table 100 via work section 110, 112, the horizontal milling tool 200 or cutting tool 207 can be used to machine the horizontal joint features such as joint faces 202, keyways, etc. The different work surfaces 104, 107 provide flexibility. For example, where second work surface 170 is provided it may provide for machining joint faces 202, while first work surface 104 may be employed for annular machining, and hand work. Slidable work sections 110, 112 also allow for improved handling and positioning of components 122, 124, e.g., when using cranes from above, and human access when manual repair work is required. With more than one table 100 available during a steam turbine outage, a substantial time savings can be realized.

In addition, table 100 may be sized in a number of ways to accommodate different sizes of circularly arcuate components. For example, base frame 102 and work sections 110, 112 may be sized to hold different sized components, and openings 138, 140 (FIG. 6) of lock 130 may be positioned to accommodate different components. In any event, table 100 allows for accurate machining of very heavy, cumbersome and sometimes mis-shaped (e.g., warped) circularly arcuate components. Table 100 and, in particular, base frame 102, work sections 110, 112, support 260, etc., may be sized to reduce vibration during machining and support the heavy circularly arcuate components 122, 124.The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A table for use in working on a circularly arcuate component, the table comprising:
a base frame;
a first work surface mounted to the base frame, the first work surface including at least one linearly slidable work section separable from a remaining portion of the first work surface; and
a fastener for holding a circularly arcuate component relative to the at least one linearly slidable work section.

2. The table of claim 1, wherein the at least one linearly slidable work section includes a pair of opposing linearly slidable work sections movable between a separated position and a proximate position in which each work section is in at least close proximity to the other work section.

3. The table of claim 2, wherein each work section positions a semi-circular arcuate component such that the semi-circular arcuate components form a circular component in response to the pair of opposing slidable work sections being in the proximate position.

4. The table of claim 2, further comprising a lock for fixing the pair of opposing linearly slidable work sections in the proximate position.

5. The table of claim 1, further comprising a second work surface positioned below the first work surface, and at least partially overlapped by the at least one linearly slidable work section.

6. The table of claim 1, wherein each linearly slidable work section is slidably mounted to the base frame by a mating linear bearing.

7. The table of claim 1, further comprising a boring bar extending through the first work surface, and a rotation power source coupled to the boring bar.

8. The table of claim 7, further comprising a first bearing for the boring bar positioned below the first work surface and a second bearing for the boring bar positioned above the first work surface.

9. The table of claim 8, further comprising a support for positioning the second bearing above the first work surface.

10. The table of claim 1, further comprising a machining tool configured to be mounted to the table for milling the circularly arcuate component.

11. The table of claim 10, wherein the machining tool includes a rotational cutting tool mounted to a boring bar extending through the first work surface, wherein, in operation, the boring bar turns the rotational cutting tool to make circumferential cuts to the circularly arcuate component.

12. The table of claim 10, wherein the machining tool includes a milling tool mounted to the at least one linearly slidable work section by a track, allowing milling of a joint face of the circularly arcuate component.

13. The table of claim 12, wherein the milling tool is pivotally mounted to the track.

14. The table of claim 10, wherein the machining tool includes a milling tool mounted to a second work surface positioned below the first work surface, allowing milling of a face of the circularly arcuate component.

15. The table of claim 10, wherein the machining tool includes a milling tool mounted to the base frame by a track, wherein the milling tool includes two oppositely facing heads, allowing milling of joint faces of a pair of opposing circularly arcuate components simultaneously.

16. The table of claim 10, wherein the machining tool includes a cutting tool mounted to the base frame by a track, wherein the cutting tool includes two oppositely facing cutters, allowing cutting of joint faces of a pair of opposing circularly arcuate components simultaneously.

17. The table of claim 1, further comprising a plurality of machining tools including:
a linear milling tool configured for mounting to the table and linear milling of a joint face of the circularly arcuate component; and
a rotational cutting tool configured for mounting to the table and rotationally milling a circumferential attribute of the circularly arcuate component.

18. The table of claim 16, wherein operation of each machining tool is electrically controlled by a control system.

19. The table of claim 1, wherein a position of the at least one linearly slidable work section is controlled by a motor system.

20. The table of claim 1, wherein the fastener includes a clamp adjustably mounted to the at least one work section.

21. The table of claim 1, wherein the table is portable.

22. The table of claim 1, wherein the table is sized to fit into a standard shipping container.

23. A multiple use table for use in working on a circularly arcuate component, the table comprising:
a base frame;
a first work surface mounted to the base frame, the first work surface including a pair of opposing linearly slidable work sections, each work section including a fastener for holding a circularly arcuate component relative thereto,
wherein the pair of linearly movable work sections are movable between a separated position in which each circularly arcuate component is separated from the other circularly arcuate component and a proximate position in which the circularly arcuate components form a circular component; and
a mount for mounting a machining tool for machining one of the circularly arcuate component in the separated position and the circular component in the proximate position.

24. A multiple use table for use in working on a circularly arcuate component, the table comprising:
a base frame;
a first work surface mounted to the base frame, the first work surface including a pair of opposing linearly slidable work sections movable between a separated position and a proximate position in which each work section is in at least close proximity to the other work section;
a fastener for holding a circularly arcuate component relative to the first work surface;
a boring bar extending through the first work surface;
a first bearing for the boring bar positioned below the first work surface and a second bearing for the boring bar positioned above the first work surface; and
a rotation power source coupled to the boring bar.

25. The multiple use table of claim 24, further comprising a plurality of machining tools including:
a linear milling tool configured for mounting to the table and linear milling of a joint face of the circularly arcuate component; and
a rotational cutting tool configured for mounting to the boring bar and rotationally milling a circumferential attribute of the circularly arcuate component.
